(19) United States
(12) Patent Application Publication
(10) Pub. No.: US 2017/0284477 A1
(43) Pub. Date: Oct. 5, 2017

(54) CONNECTOR ARRANGEMENT FOR CENTERING TWO SHAFT SECTIONS TO BE CONNECTED WITH ONE ANOTHER

(71) Applicant: SUEDDEUTSCHE GELENKSCHEIBENFABRIK GMBH & CO. KG, Waldkraiburg (DE)

(72) Inventors: Stephan Petrik, Haag/Winden (DE); Martin Wandinger, Reichertsheim (DE); Franz Kobus, Jettenbach (DE)

(21) Appl. No.: 15/473,876

(22) Filed: Mar. 30, 2017

(30) Foreign Application Priority Data
Mar. 30, 2016 (DE) 10 2016 003 917.5

(51) Int. Cl. F16D 3/68; F16J 15/02

(52) U.S. Cl. CPC F16D 3/68; F16J 15/025

(57) ABSTRACT

A connector arrangement is provided for centering two shaft sections to be connected with one another, having at least one outer connector having a longitudinal axis, and at least one inner connector disposed radially inward from the at least one outer connector, with reference to the longitudinal axis. The outer connector and the inner connector are connected by way of at least one elastomer body, which is connected with at least one sealing lip. The sealing lip is configured with a C profile, viewed in a cross-section that contains the axis, wherein one end of the C profile is connected with the elastomer body and wherein the other end of the C profile is configured as a free end for the purpose of coming into contact with a shaft section, forming a seal.

The present invention relates to a connector arrangement for centering two shaft sections to be connected with one another, having:
at least one outer connector having a longitudinal axis, and
at least one inner connector disposed radially inward relative to the at least one outer connector, with reference to its longitudinal axis,
   wherein the at least one outer connector and the at least one inner connector are connected by way of at least one elastomer body, which is connected with at least one sealing lip.

Such connector arrangements are known from the state of the art and are disclosed, for example, in the documents DE 20 2013 006 359 U1, DE 195 31 201 A1, and WO 2004/097239 A1.

The German utility model DE 20 2013 006 359 U1 shows and describes a connector arrangement in accordance with the preamble of claim 1. In this regard, the sealing lip is formed by a recess that projects relatively far into the elastomer body, so that locally, the connection of the inner connector to the outer connector by way of the elastomer body is weakened by the recess. Furthermore, the sealing lip is connected relatively firmly with the inner connector, so that the lip has only slight flexibility, particularly if the shaft section contacted by the sealing lip is subject to strong bending angle deflection.

The document DE 195 31 201 A1 discloses a centering apparatus having a sleeve-shaped centering collar, to which a rubber spring arrangement is attached. The rubber spring arrangement extends between the centering collar and an inner connector, which can guide a centering journal. The rubber spring arrangement encompasses the inner connector and comprises a sealing lip. The rubber spring arrangement completely fills the radial region between the centering collar and the inner connector, subsequent to the sealing lip.

WO 2004/097239 A1 discloses a bearing having a tubular piece and an insert set into the tubular piece. The central insert is embedded in an elastic centering sleeve composed of rubber and vulcanized onto it. A first ring-shaped sealing lip and a second ring-shaped sealing lip are formed on the centering sleeve. The elastic centering sleeve completely fills the radial region between the tubular piece and the central insert, between the two sealing lips.

The apparatuses for centering two shaft sections to be connected with one another that are known from the state of the art are frequently used and have certainly proven themselves in practice.

However, it has been shown that relatively great bending angles, i.e. greater than 3°, occur more frequently between the shaft sections to be connected, due to further developments, for example in the case of steering shafts and drive trains in the motor vehicle sector.

The applicant has recognized that in the case of greater bending angles, lifting of the sealing lip from a centering journal, for example, can occur under some circumstances, and thereby the sealing function of the centering device or connector arrangement can be impaired or cancelled out entirely.

Accordingly, it is a task of the present invention to further develop a connector arrangement of the type described initially, in such a manner that it fulfills its function safely and reliably even at relatively large bending angles.

This task is accomplished by an apparatus for centering two shaft sections to be connected with one another, having the characteristics of claim 1.

The invention provides that the sealing lip is configured with a C profile, viewed in a cross-section that contains the axis, wherein one end of the C profile is connected with the elastomer body and wherein the other end of the C profile is configured as a free end, so that it comes into contact with a shaft section and forms a seal.

Such an embodiment of the sealing lip makes it possible for the sealing lip to deform correspondingly greatly even at great bending angles, because of the deformability of the C profile, and to continue to remain in sealing contact with the surface of the shaft section with its free end. This is the case even if the bending angle or the displacement of the shaft section periodically changes quickly, for example in the case of strong vibrations of the shaft section. Contrary to the state of the art, the sealing lip offers very good deformation capacity because of its C-profile-shaped configuration, and thereby guarantees permanent sealing contact even in the case of a long period of operation and great bending angles.

Further embodiments of the invention are evident from the attached dependent claims.

A further development of the invention provides that the radially outer end of the C profile, with reference to the longitudinal axis, is connected with the elastomer body, and the radially inner end of the C profile, with reference to the longitudinal axis, is configured as a free end for sealing contact with the shaft section.

Furthermore, it can be provided, according to the invention, that the free end is configured to be rounded, wherein the free end is preferably provided with a ring section configured as a thickened material region. In an embodiment of the free end as a ring section with thickened material, wear effects in the region of the free end can be taken into account even better.

According to an embodiment variant of the invention, it can be provided that at least one recess that runs around the longitudinal axis is formed in the elastomer body, which recess extends into the elastomer body at an axial end of the connector arrangement, wherein the at least one recess runs around the at least one sealing lip.

An embodiment variant of the invention provides that the at least one recess in the elastomer body extends all the way to the face surface of the at least one inner connector.

In this regard, it can be provided, according to the invention, that the at least one recess extends essentially parallel to the inner circumference surface of the outer connector, axially into the elastomer body, wherein the C-profile-shaped sealing lip is connected with the elastomer body radially within the recess.

Alternatively to a radial expanse of the recess, a further development of the invention provides that the recess extends essentially radially with reference to the longitudinal axis of the connector arrangement, wherein the recess runs radially between the inner connector and the sealing lip.

In order to guarantee the deformation possibility of the sealing lip as addressed above, it can furthermore be provided, according to the invention, that the sealing lip is configured with sufficient axial play relative to the elastomer body and/or relative to the inner connector so that the sealing lip follows a deflection movement of the shaft section relative to the longitudinal axis by a bending angle of up to 5°, preferably of up to 8°, most preferably of up to 10°, with elastic deformation and continuous sealing contact on the shaft section.

With regard to the configuration of the C profile, it is possible, according to the invention, that the sealing lip has a first C-profile section that runs essentially parallel to the longitudinal axis and by way of which the sealing lip is connected with the elastomer body, that the sealing lip furthermore has a second C-profile section that runs essentially radially to the longitudinal axis, and that the sealing lip furthermore has a third C-profile section that is connected with the first C-profile section by way of the second C-profile section and has the free end configured for contact with the shaft section. Alternatively to this, it can be provided, according to the invention, that the sealing lip is configured in the form of a harmonically curved material section, preferably in the form of an arc segment. Furthermore, it is possible to provide intermediate forms of these, for example in such a manner that individual sections of the C profile are disposed at an angle relative to one another and other sections are connected with one another in harmonically curved manner over the further progression.

According to the invention, it can be provided that the sealing lip is configured with a constant wall thickness toward the free end, proceeding from the elastomer body, or alternatively that the sealing lip is configured with a decreasing or increasing wall thickness.

Depending on the application case, it can preferably be provided, according to the invention, that the sealing lip is configured to be convex or concave with reference to the inner region of the connector arrangement. The selection of one of these two invention variants can be based on what movement pattern and what maximal deflection angles are to be expected during operation for the shaft section to be accommodated.

A further development of the invention provides that the at least one inner connector has a circumferential section that projects in the direction of the outer connector. In this regard, it is possible that the radially outer mantle surface of the inner connector, viewed in the axial direction, comprises a section that runs parallel to the center axis and is connected with the section that projects in the direction of the outer connector, by way of a convex section, wherein a further convex section that makes a transition into a section that runs parallel to the center axis of the connector arrangement follows the projecting section, wherein a bevel is provided at the axial ends of the inner connector, in each instance. Furthermore, it can be provided, according to the invention, in this connection, that the radially outer mantle surface of the inner connector is completely encompassed by the elastomer body.

A further development of the invention provides that the elastomer body covers the face surfaces of the inner connector at least in certain sections. In particular, it can be provided, in this connection, that the inner circumference surface of the outer connector is completely covered with the elastomer body.

The sealing lip can be configured separately and be affixed to the elastomer body as a separate component, for example by means of gluing or other types of shape-fit connections, but if applicable also by means of affixation using additional elements, for example using a clamping ring. Preferably, however, it is provided, according to the invention, that the sealing lip is configured integrally with the elastomer body, i.e. is formed onto this body integrally during production.

The invention furthermore relates to a centering apparatus having a connector arrangement of the type described above. Furthermore, the invention also relates to a torque transfer apparatus having a connector arrangement of the type described above.

In the following, exemplary embodiments of the present invention will be described with reference to the attached figures. These show:

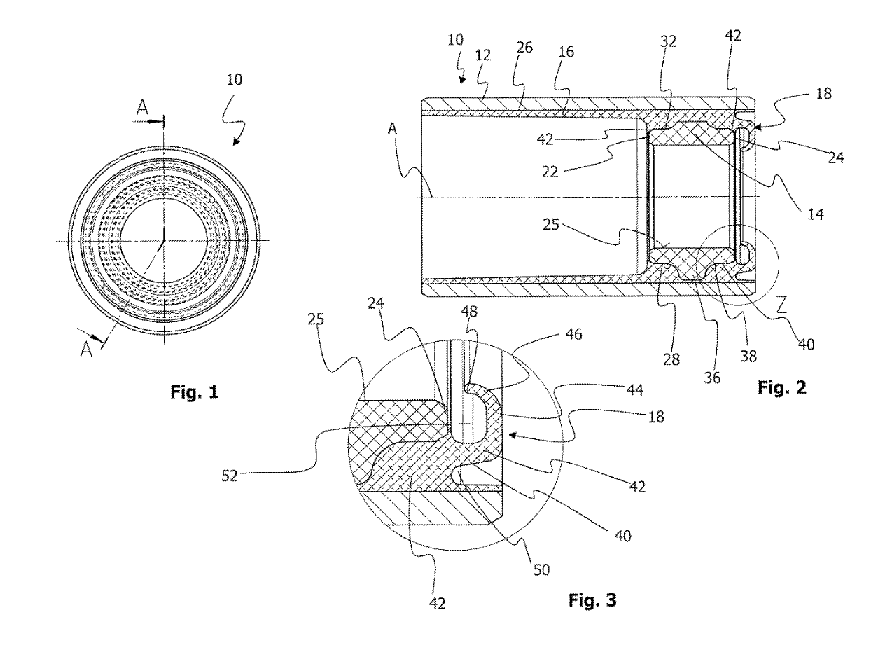

FIG. 1 a front view of a connector arrangement according to a first embodiment of the present invention;

FIG. 2 a sectional view of the connector arrangement according to the first embodiment of the invention, which view contains the axis;

FIG. 3 an enlarged detail view of Detail Z in FIG. 2;

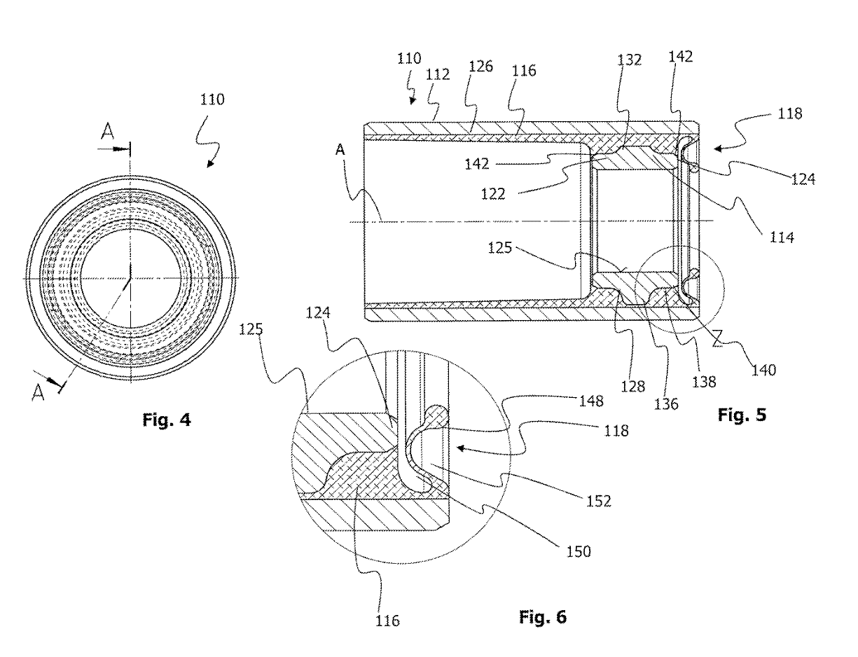

FIG. 4 a front view of a connector arrangement according to a second embodiment of the present invention;

FIG. 5 a sectional view of the connector arrangement according to the second embodiment of the invention, which view contains the axis;

FIG. 6 an enlarged detail view of Detail Z in FIG. 5.

FIGS. 1 to 3 show a first embodiment of a connector arrangement according to a first embodiment of the invention, which is referred to in general as 10.

The connector arrangement 10 comprises an outer connector 12 and an inner connector 14. The outer connector 12 and the inner connector 14 are connected with one another by way of an elastomer body 16. A sealing lip 18 is configured on the elastomer body 16, which lip is configured with a C profile in cross-section, according to FIGS. 2 and 3. The sealing lip 18 is configured for sealing contact with the outer circumference surface of a shaft section (not shown) to be accommodated, for example, or of a centering journal (not shown) of a centering apparatus.

In FIG. 1, the section progression A-A of the cross-section according to FIG. 2, which contains the axis, can be seen.

The outer connector 12 is configured to be tubular and encompasses the inner connector 14 and the elastomer body 16 radially. Both the outer connector 12 and the inner connector 14 are bodies that have rotation symmetry.

The outer connector 12 is connected with the inner connector 14 by way of the elastomer body 16. The inner connector 14 has two axial face surfaces 22 and 24, which are both essentially exposed. Furthermore, the inner connector 14 has an inner circumference surface 25.

The elastomer body 16 is connected with the mantle surface 28 of the inner connector 14 and spans the face surfaces 22 and 24 of the inner connector 14. If applicable, the elastomer body can also be completely connected with the face surfaces 22 and 24 of the inner connector 14 or attached to these face surfaces 22 and 24. To attach the elastomer body 16 to the outer connector 12 and the inner connector 14, an adhesion imparting agent is first applied, and subsequently the elastomer body 16 is vulcanized onto the inner circumference surface 26 of the outer connector 12 and to the mantle surface 28 of the inner connector 14.

The elastomer body 12 [sic—should be 16] is provided completely on the inner circumference surface 26 of the outer connector 12, i.e. a thin elastomer layer spans the inner circumference surface 26 of the outer connector 12 even in the region of the recess 20.

The inner connector 14, i.e. its mantle surface 28 has a predetermined contour. Proceeding from the face surface 22, a section 32 that extends parallel to the center axis A is provided, which section is connected, by way of a convex section 34, with a section 36 that projects in the direction of the outer connector 12. The projecting section 36 is connected with a convex section 38, which makes a transition into a section 40 that runs linear to the center axis A. A circumferential bevel 42 is provided on the face surface 22 and 24, i.e. at the transitions of the face surfaces 22 and 24 to the sections 34 and 40 that run parallel to the center axis A, in each instance.

If one now turns to the sealing lip 18, it can be seen, particularly in FIG. 3, that this lip is configured integrally on the section 42 of the elastomer body 16, which section is disposed radially outside of the inner connector 14, by way of a first section 40. In this regard, the sealing lip 18 is directly integrally attached to the elastomer body 16. This first section 40 has a relatively great material thickness and extends essentially parallel to the direction of expanse of the longitudinal axis A of the connector arrangement 10. This first section 40 makes a transition, by way of a rounded transition section 42, into a second section 44 that extends essentially radially to the longitudinal axis A. This second section 44 has a slightly lesser material thickness than the first section 40. The second section 44 extends radially inward toward the central center axis A of the inner connector. The second section 44 extends toward a free end 48, by way of a third section 46 that is configured to be rounded; in FIG. 3, this end is curved toward the left. This free end 48 is configured to be rounded and projects radially inward beyond the inner circumference surface 25 of the inner connector 14.

A recess 50 extends radially outside the sealing lip 18, into the elastomer body. This recess 50 ensures that the sealing lip 18 can be displaced radially outward, particularly with its first section 40, and thereby its deformation capacity is increased.

Furthermore, it can be seen that a free space 52 between the face surface 24 of the inner connector 14 and the second section 44 of the sealing lip 18 occurs due to the form of the sealing lip and its arrangement on the elastomer body 16. This free space 52 also allows far-reaching deformation of the sealing lip in the event of stress, wherein the sealing lip can deform in such a manner that the second section 44 as well as the third section 46 can move into this free space with the free end 48.

In an installation situation in which a shaft section or a bearing journal is accommodated in the inner connector 14 so as to be mounted in it, the sealing lip 18 lies against the outer circumference surface of the shaft section or of the bearing journal with its free end 48, over the full area, forming a seal, and is already deformed during this process. Because of the C-profile-shaped configuration of the sealing lip 18 and the expansion space that is available due to the recess 50 and the free space 52, the sealing lip can deform to a sufficiently great extent so that sealing contact with the outer circumference surface of the shaft section is guaranteed. This is the case even if the shaft section is displaced in terms of its orientation relative to the longitudinal axis A as the result of bending stresses, for example with radial offset or with an angle offset relative to the longitudinal axis A in the case of an essentially parallel orientation. In both cases, the sealing lip continues to remain in sealing contact with the outer circumference surface of the shaft section because of its C-profile-shaped configuration and the expansion space that is available due to the recess 50 and the free space 52.

In the following, a further embodiment of the present invention will be described with reference to FIGS. 4 to 6. The same reference symbols are used for components of the same type and having the same effect, but with the number “1” preceding them.

The connector arrangement 110 comprises an outer connector 112 and an inner connector 114, which are connected with one another by way of an elastomer body 116. A sealing lip 118 is formed on the elastomer body 116, which lip follows the inner connector 114 in the axial direction. The embodiment according to FIGS. 4-6 differs from the embodiment according to FIGS. 1-3 in terms of the configuration of the sealing lip 118.

The sealing lip 118 is also configured in C-profile shape, with harmonic arc-shaped rounding. However, it is integrally formed on in its radially outer region 160, by way of a thickened material region on the elastomer body 116, then extends radially inward, in convex shape, with the formation of a cavity 152. At its radially inner end, the sealing lip 118 has a ring-shaped region 148 of thickened material, having a circular cross-section, which region is configured to come into sealing contact with the outer circumference surface of the shaft section accommodated in the inner connector 114. A bulbous recess 150 is provided between the sealing lip 118 and the face surface of the inner connector 114 as well as the part of the elastomer body 116 that follows it.

The combination of the C-profile-shaped sealing lip 118, the cavity 152, and the recess 150 allows extensive and unhindered deformation of the sealing lip during operation. In this way, it is guaranteed that the sealing lip, with its ring-shaped region 148 of thickened material, lies on the outer circumference surface of the shaft section fully and forming a seal, even at relatively great bending angles of a shaft section accommodated in it. The thickened material region 148 increases the wear resistance of the sealing lip 118 and its sealing effect.

Both embodiments of the invention that have been described in detail provide for a sealing lip 18 or 118, respectively, which offers great degrees of freedom in deformation and at the same time guarantees, in spite of great deformation, that the free end of the sealing lip lies against the outer circumference surface of the shaft section, forming a seal, even at great deflection of an accommodated shaft section and even after a long period of operation. The sealing lip 18 or 118, respectively, is wear-resistant. Depending on the embodiment, it has a sealing effect at bending angles up to 10°.

1. A connector arrangement for centering two shaft sections to be connected with one another, having:
at least one outer connector having a longitudinal axis, and
at least one inner connector disposed radially inward from the at least one outer connector, with reference to the longitudinal axis,
wherein the at least one outer connector and the at least one inner connector are connected by way of at least one elastomer body, which is connected with at least one sealing lip,
wherein the sealing lip is configured with a C profile, viewed in a cross-section that contains the axis, wherein one end of the C profile is connected with the elastomer body and wherein the other end of the C profile is configured as a free end for the purpose of coming into contact with a shaft section, forming a seal.

2. The connector arrangement according to claim 1,
wherein the radially outer end of the C profile, with reference to the longitudinal axis, is connected with the elastomer body, and the radially inner end of the C profile, with reference to the longitudinal axis, is configured as a free end for the purpose of making contact with the shaft section, forming a seal.

3. The connector arrangement according to claim 1,
wherein the free end is configured to be rounded, wherein the free end is preferably provided with a ring section configured as a thickened material region.

4. The connector arrangement according to claim 1,
wherein at least one recess that runs around the longitudinal axis is formed in the elastomer body, which recess extends into the elastomer body at an axial end of the connector arrangement, wherein the at least one recess runs around the at least one sealing lip.

5. The connector arrangement according to claim 4,
wherein the at least one recess in the elastomer body extends all the way to the face surface of the at least one inner connector.

6. The connector arrangement according to claim 4,
wherein the at least one recess extends into the elastomer body essentially parallel to the inner circumference surface of the outer connector, wherein the C-profile-shaped sealing lip is connected with the elastomer body radially within the recess.

7. The connector arrangement according to claim 1,
wherein the recess extends essentially radially with reference to the longitudinal axis of the connector arrangement, wherein the recess runs radially between the inner connector and the sealing lip.

8. The connector arrangement according to claim 1,
wherein the sealing lip is configured with sufficient axial play relative to the elastomer body or the inner connector, so that the sealing lip follows a deflection movement of the shaft section relative to the longitudinal axis by a bending angle of up to 5° or of up to 8° or of up to 10°, with elastic deformation and permanent sealing contact on the shaft section.

9. The connector arrangement according to claim 1,
wherein the sealing lip has a first C-profile section that runs parallel to the longitudinal axis and by way of which the sealing lip is connected with the elastomer body, that the sealing lip furthermore has a second C-profile section that runs radially to the longitudinal axis, and that the sealing lip furthermore has a third C-profile section that is connected with the first C-profile section by way of the second C-profile section and has the free end configured for contact with the shaft section.

10. The connector arrangement according to claim 1,
wherein the sealing lip is configured in the form of a harmonically curved material section or in the form of an arc segment.

11. The connector arrangement according to claim 1,
wherein the sealing lip is configured with a constant wall thickness toward the free end, proceeding from the elastomer body toward the free end, or configured with a decreasing or increasing wall thickness.

12. The connector arrangement according to claim 1,
wherein the sealing lip is configured to be convex or concave with reference to the inner region of the connector arrangement.

13. The connector arrangement according to claim 1,
wherein the at least one inner connector has a circumferential section that projects in the direction of the outer connector.

14. The connector arrangement according to claim 1,
wherein the sealing lip is configured integrally with the elastomer body.

15. A centering apparatus having a connector arrangement according to claim 1.
